(19) United States
(12) Patent Application Publication
(10) Pub. No.: US 2014/0106657 A1
(43) Pub. Date: Apr. 17, 2014

(54) Aseptic embodiment and process for aseptic preparation and storage of drugs and cosmetics in aseptic contained environment

(71) Applicant: Joseph Urban, Richboro, PA (US)

(72) Inventor: Joseph Urban, Richboro, PA (US)

(21) Appl. No.: 13/573,870

(22) Filed: Oct. 11, 2012

(51) Int. Cl. B08B 15/02

(52) U.S. Cl. CPC B08B 15/023
USPC 454/56

(57) ABSTRACT

The ASEPTIC EMBODIMENT is an invention which will store, allow mixing and preparation of aseptic products, and permit storage of the mixed or prepared product in an aseptic environment until administered to a patient or customer. The ASEPTIC EMBODIMENT is portable and can be easily relocated when needed. The ASEPTIC EMBODIMENT will provide satisfaction of USP <797> regulations and therefore benefit society by decreasing or eliminating contamination of products which should be stored, prepared and administered under aseptic conditions. End result, it will decrease healthcare costs.

### FIELD OF THE INVENTION

This invention relates to the field and Pharmacy and more specifically to the storage, preparation, packaging, filling, mixing, and storage of prepared product under aseptic conditions. These aseptic products are commonly referred to as sterile products, injectables, eye drops, ear drops, parenteral solutions, intravenous injections, intra-arterial injections, intramuscular injections, intra-dermal injections, subcutaneous injections as well as other injections, tablets, capsules, rods, and other objects for insertion into or onto the body requiring aseptic preparation.

### BACKGROUND OF THE INVENTION

Parenteral and sterile products are usually required to be sterile at the time of injection into or application to the human body. Pharmaceutical manufacturers of Sterile Products must follow a plethora of regulations and current Good Manufacturing Processes such as: 21 CFR 210; 21CFR 211; 21 CFR 11; USP <797>; CGAMP; GLP; GCP; Cleaning Validations; WHO Requirements; Re-Validation Requirements, just to name a few. For parenteral and sterile products, these regulations have a few objectives in common: TO INSURE THAT THE FINISHED PRODUCT IS SAFE FOR HUMAN USE; THAT IT IS EFFECTIVE: and, if it is a sterile product, THAT IT REMAINS STERILE UNTIL ADMINISTRATION TO A HUMAN or ANIMAL.

As professionals, the doctors, nurses, pharmacists, dentists, veterinarians and others who administer injections should maintain the sterility of the product through purchase to administration to a patient.

However, in a multitude of cases, this is not so. Examining the average pharmacy one should be able to observe some, if not most, of the following when an injection is prepared and opened in the pharmacy's open laboratory and administered to the next customer or patient in line. The common areas of contamination are, but not limited to: dirt, dust, food, paperwork, contaminated prescriptions, exposed trash, etc. on lab surface; dirt, stains, dust on floors, rugs and walls; air vents laden with dust and mold just blowing down on the injection; the professional to administer the injection has exposed hair, hands, nails and lab coat all contributing to the contamination; the sink area with filth, rust, sponges, equipment not cleaned and water which may not be fit to drink; direct access to outside in pharmacies with drive-through; customers and patients coughing, spitting, sneezing, blowing their noses, touching and contaminating the counter and lab; a professional opens the vaccine vial with 10 doses in it and wipes the stopper with a 70% alcohol swab that is not even sterile, withdraws 1 dose and replaces the opened vial in the filthy refrigerator which may not have been cleaned since it was originally put into service. If the FDA would enter a sterile drug manufacturer with these infractions of cGMPs ongoing, the would certainly receive an FDA483 or FDA Warning Letter. The manufacturing site, may even be shut down and all products produced recalled.

It is just not Pharmacy at fault, many of the same conditions and worse can be found in Doctor's Offices, Clinics, Hospitals, various stores, gas stations, and other places of vaccine administration. It is sad that the professional worries about getting the vaccine or injection into the patient but doesn't care about the handling and contamination of the sterile drug.

By contrast, this invention keeps the injection in a USP <797> environment during storage, preparation, and storage of finished preparation until administration to patient or customer.

### SUMMARY OF THE INVENTION

The present invention includes an embodiment which will store, allow mixing and preparation of aseptic products, and permit storage of the mixed or prepared product in an aseptic environment until administered to a patient or customer.

The invention also provides an embodiment which is portable and can be easily relocated when needed.

Another feature of the invention is that it will provide satisfaction of USP <797> regulations and therefore benefit society by decreasing or eliminating contamination of products which should be stored, prepared and administered under aseptic conditions. End result, it will decrease healthcare costs.

### DESCRIPTION OF THE FIGURES

The features of the invention believed to be novel and the elements characteristic of the invention are set forth with particularity in the claims. The figures are for illustration purposes only and are not drawn to scale. The invention itself, however, both as to organization and method of operation, may best be understood by reference to the detailed description that follows taken in conjunction with the accompanying drawings in which:

FIG. 1 is a front view of one embodiment of the present invention in which the embodiment shown is presented as a typical design with the temperature/humidity control system and air filtration system attached to the back of the embodiment;

FIG. 2 is a side view of the embodiment of FIG. 1 with the temperature/humidity control system attached to the back of the embodiment;

FIG. 3 is a top view of the embodiment of FIG. 1 with the temperature/humidity control system and air filtration system attached to the back of the embodiment;

FIG. 4 is a front view of one embodiment of the present invention in which the embodiment shown is presented as a typical design with the temperature/humidity control system and air filtration system attached to the bottom of the embodiment and plenums feeding from them into the embodiment from the back;

FIG. 5 is a front view of one embodiment of the present invention in which the embodiment shown is presented as a typical design with the temperature/humidity control system on the bottom and feeding ante-rooms located on both sides of the embodiment through plenums and the air filtration system attached to the back and feeding into the embodiment;

### DETAILED DESCRIPTION OF THE INVENTION

This invention will now be described with reference to specific embodiments selected for illustration in the figures. It will be appreciated that the spirit and scope of this invention is not limited to the embodiments selected for illustration. Instead, the scope of this invention is defined separately in the appended claims. Also, it will be appreciated that the drawings are not rendered to any particular proportion or scale.

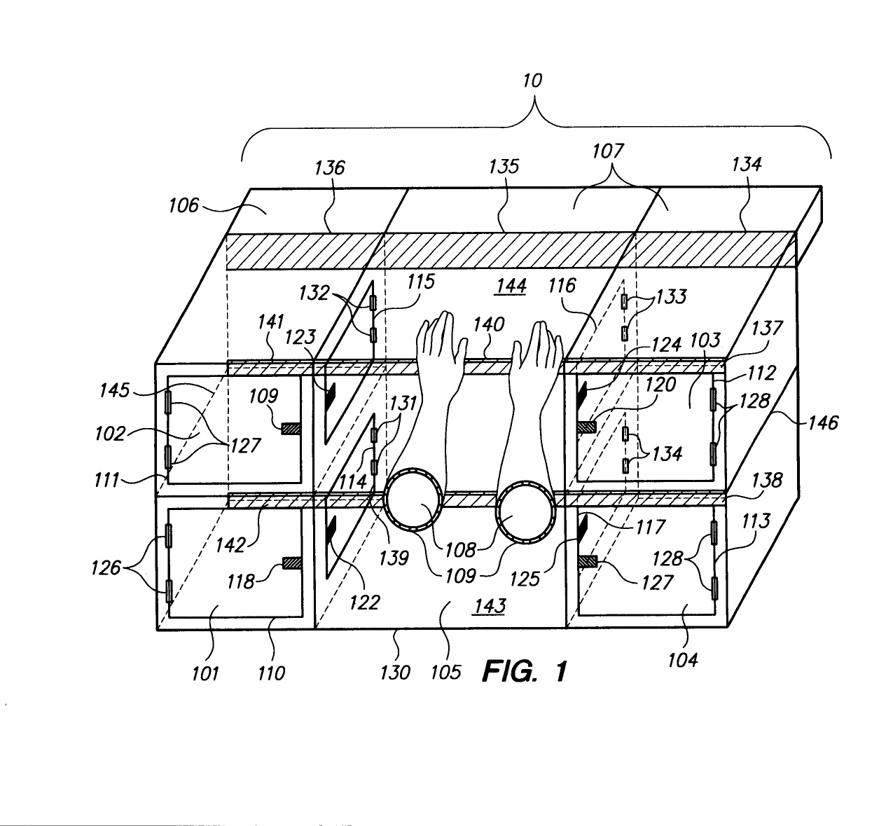

FIG. 1 shows a front view of one of the envisioned Aseptic Embodiments designated by the numeral “10”. The Aseptic Embodiment 10 has a series of Ante-Chambers “101”, “102”, “103”, and “104” attached to a Product Exposure Chamber “105”. Located on the back of the Aseptic Embodiment 10 are located an Air Temperature/Humidity Control System “106” and an Air Filtration System “107”. Located on the outer surface of Product Exposure Chamber 105 and extending into the chamber are Protective Gloves “108” allowing one to put hands and arms into gloves to manipulate products in the Ante-Chambers 101, 102, 103, 104, and Product Exposure Chamber 105 without compromising the aseptic environment. Glove Seal “109” maintains the integrity and prevents any air or gas passage from the inside of the Ante-Cambers 101, 102, 103, 104 and Product Exposure Chamber 105 to the outside of the Aseptic Embodiment.

On each of the Ante-Chambers 101, 102, 103, 104 are located an Outer Door “109” opening to the outside and an Inner Door “110” opening into the Product Exposure Chamber 105. Inner doors 110 have adjustable air flow filter devices on them. Outer Doors 109 and Inner Doors 110 have located on them Door Handle/Lock Device 113 and Hinge Attachments 114 to function. All doors are air tight.

Generally, Ante-Chambers 101, 102, 103, and 104, as well as Product Exposure Chamber 105, are constructed of acrylics, plastics, paper, foam, fabrics, fiber, rubber, glass, metal, cloth, and similar materials and/or combinations thereof. Preferably most the materials used are of light-weight and transparent or semi-transparent. All attachments as well as Chambers, Doors, Handles, Hinges, Flanges, Temperature Humidity Control System, Air Filtration and Gloves may be attached by flanges, screws, nuts/bolts, epoxy, adhesives, glues, melted plastics, acrylics or other means to achieve desired controlled conditions.

Filtered Air-In Adjustable Vents “111” and Air-Out Adjustable Vents “112” are located on the back walls of the chambers.

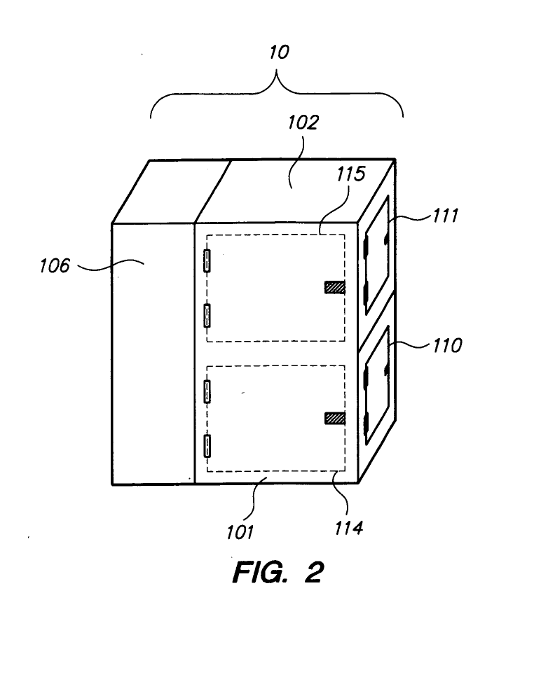

FIG. 2 Shows a side view of the Aseptic Embodiment 10 with Temperature/Humidity Control System 106 located behind Ante-Chambers 101 and 102.

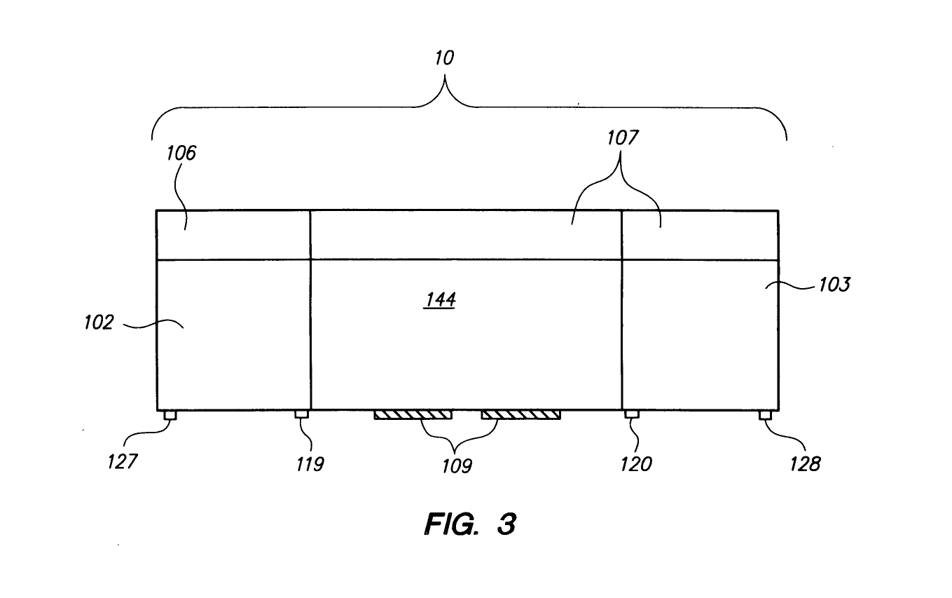

FIG. 3 Shows a top view of the Aseptic Embodiment 10 with Temperature/Humidity Control System 106 and Air Filtration System 107 located behind the Ante-Chambers 102 and 103 and Product Exposure Chamber 105.

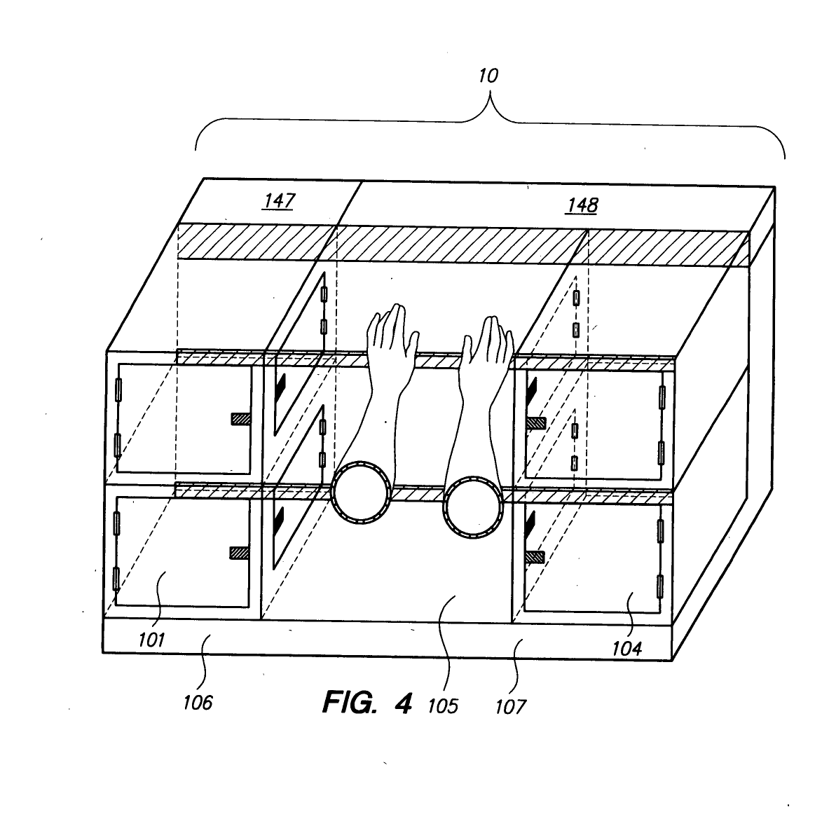

FIG. 4 Shows a front view of the Aseptic Embodiment 10 with the Temperature/Humidity Control System 106 and Air Filtration System 107 located on the bottom of Ante-Chambers 101 and 104 and Product Exposure Chamber 105.

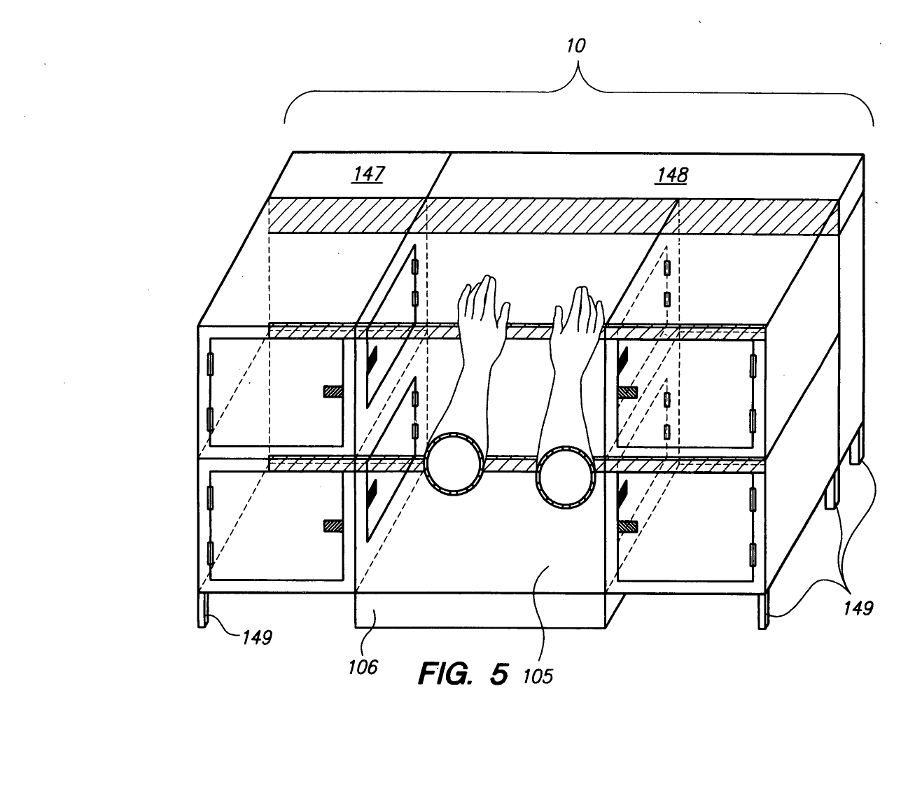

FIG.5 Shows a front view of the Aseptic Embodiment 10 with a Temperature/Humidity Control System 106 on the bottom of Product Exposure Chamber 105 and the Air Filtration System 107 located behind Product Exposure Chamber 5.

Accordingly, while illustrated and described herein with reference to certain specific embodiments, the present invention is not intended to be limited to the embodiments and details shown. Rather, the following claims are intended to include embodiments and modifications that may be made to these embodiments and details, which are nevertheless within the true spirit and scope of the present invention.

### REFERENCES CITED

United States patents

| | | |
|---|---|---|
| 5,058,491 | October 1991 | Wiemer, et al. |
| 4,838,150 | June 1989 | Suzuki, et al. |
| 4,826,360 | May 1989 | Iwasawa et al. |
| 4,781,511 | November 1988 | Harada, et al. |
| 4,724,874 | February 1988 | Parikh, et al. |
| 4,587,793 | May 1986 | Brennan, et al. |
| 4,522,015 | June 1985 | Hildebolt |
| 4,372,100 | February 1983 | Miller, et al. |
| 4,332,122 | June 1982 | Williams |
| 3,815,315 | June 1974 | Glick |

Current U.S. Class: 53/425; 53/111R; 53/428; 53/434

Current International Class: A61J 3/00 (20060101)

Field of Search: 53/425; 53/111R; 53/428; 53/434; 454/187; 454/49

I claim:

1. An apparatus for the preparation of aseptic pharmaceutical products comprising:
one or more product exposure chambers wherein injections can be prepared aseptically by use of gloves extending into product exposure chamber
one or more product exposure chambers wherein injections can be prepared aseptically by use of two or more pairs of gloves extending into product exposure chamber where one pair is a back-up in case of tear or puncture
one or more ante-chambers attached to product exposure chamber said ante-chamber having entrance from outer room area and entrance to ante-chamber
filtered clean air as described by USP <797> supplied to product exposure chamber(s) and ante-chamber(s) accordingly

2. The apparatus as described in claim 1 further comprising:
meter means for controlling airflow into and out of product exposure chamber(s)
meter means for controlling airflow into and out of ante-chamber(s)
means for monitoring, adjusting and recording airflow into and out from all chamber(s)
sealing means for sealing product exposure chamber(s) and ante-chamber(s) to each other

3. The apparatus as described in claim 2 further comprising:
one or more of the ante-chambers having a temperature/humidity control system
means for monitoring, adjusting and recording temperature and humidity
means for monitoring, adjusting and recording pressure within the chamber(s) and outside of the chamber(s)

4. The apparatus as described in claim 3 further comprising:
one or more of the product exposure chambers having a temperature/humidity control system
means for monitoring, adjusting and recording temperature and humidity
means for monitoring, adjusting and recording pressure within product exposure chamber(s) and outside of the product exposure chamber(s)

5. The apparatus as described in claim 1 further comprising:
additional parts in the product exposure chamber(s) and ante-chamber(s) if needed consisting but not limited to lights, holding rods, shelves and other accessories commonly used in hoods and glove-boxes

6. An apparatus designed to protect toxic products from contaminating the surrounding room and atmosphere comprising
one or more product exposure chamber(s) wherein toxic products can be prepared aseptically by use of gloves extending into product exposure chamber(s)
one or more product exposure chamber(s) wherein toxic products can be prepared aseptically by use of two or more pairs of gloves extending into product exposure chamber(s) where one pair is a back-up in case of tear or puncture
one or more ante-chamber(s) attached to product exposure chamber(s) said ante-chamber(s) having entrance from outer room area and entrance to ante-chamber(s) or product exposure chamber(s)
filtered clean air as described by USP <797> supplied to product exposure chamber(s) and ante-chamber(s) accordingly
filtered exhaust, said exhaust exerting a greater than the air in thus exerting a negative pressure on the product exposure chamber(s) and ante-chamber(s)

7. The apparatus as described in claim 6 further comprising:
meter means for controlling airflow into and out of product exposure chamber(s)
meter means for controlling airflow into and out of ante-chamber(s)
means for recording airflow into and out from all chamber(s)
means for monitoring, adjusting and recording pressure within the chamber(s) and outside of the chamber(s)
sealing means for sealing product exposure chamber(s) and ante-chamber(s) to each other

8. The apparatus as described in claim 7 further comprising:
one or more of the ante-chambers having a temperature control system means for monitoring, adjusting and recording temperature and humidity

9. The apparatus as described in claim 8 further comprising:
one or more of the product exposure chamber(s) having a temperature control system means for monitoring, adjusting and recording temperature and humidity

10. The apparatus as described in claim 9 further comprising:
additional parts in the product exposure chamber(s) and ante-chamber(s) if needed consisting but not limited to lights, holding rods, shelves and other accessories commonly used in hoods and glove-boxes
